(19) United States
(12) Patent Application Publication
(10) Pub. No.: US 2004/0187142 A1
(43) Pub. Date: Sep. 23, 2004

(54) Disk tray unit and disk rotational device

(76) Inventor: Tomokazu Namiki, Tokyo (JP)

Correspondence Address: DICKSTEIN SHAPIRO MORIN & OSHINSKY LLP, 2101 L STREET NW, WASHINGTON, DC, 20037-1526, US

(21) Appl. No.: 10/765,394

(22) Filed: Jan. 28, 2004

(30) Foreign Application Priority Data
Jan. 29, 2003 (JP) 2003-020107

(51) Int. Cl. G11B 17/03

(52) U.S. Cl. 720/603

(57) ABSTRACT

A disk tray unit is disclosed that enables suppressing noise generated when a disk rotates. The disk tray unit includes a tray having a recessed portion for accommodating the disk and eaves for holding the disk. The front end of each eave has a smooth shape without unevenness. The eaves are formed on the peripheral wall of the recessed portion and projects toward the inner side of the recessed portion so as to face a portion of the side edge of the disk set in the recessed portion. Because the front end of the eaves has a smooth shape without unevenness, resistance of the eaves to the air stream when the disk rotates is reduced, and thus the probability of generating Karman vortices is reduced. Consequently, it is possible to suppress wind roar and reduce noise generated when the disk rotates.

### BACKGROUND OF THE INVENTION

1. Field of the Invention

The present invention relates to a disk tray unit and a disk rotational device, and more particularly, to a disk tray unit suitable for loading a disk into the disk rotational device and unloading the disk from the disk rotational device, and the disk rotational device including the disk tray unit.

2. Description of the Related Art

In the recent years and continuing, along with rapid progress in multimedia technology and digital apparatuses, the amount of information that needs to be processed increases drastically, and larger and larger capacities are required for various storage media. In computers, audio or video devices, optical disks are incorporated for storing information. Examples of the optical disks include CDs (Compact Disk) and DVDs (Digital Versatile Disk) having the same size as CDs but seven times the capacity. An optical disk drive is used to record information on and reproduce information from an optical disk. The optical disk drive emits a laser beam to the recording surface of the disk while driving the disk to rotate, thereby forming mark regions and space regions on the recording surface of the disk. In this way, the optical disk drive records information on the disk, or reads the recorded information from the disk by detecting reflected light from the disk recording surface using a light sensor, which converts the detected reflected light to electrical signals.

The optical disk drive includes a main unit in which an optical pickup is installed; a disk tray unit that has a plate-like recessed portion for accommodating a loaded optical disk and allowing an optical disk to be loaded therein or unloaded therefrom freely, and is movably attached to the main unit so as to be able to move into and out of the main unit through an opening formed on the front surface of the main unit; and an optical disk turning mechanism that rotates the optical disk set in the recessed portion when the disk tray unit is set at its position inside the main unit. In addition, the optical disk drive further includes a mechanism for holding a driving device of the optical pickup and the optical disk turning mechanism, and a front panel formed with the opening allowing the disk tray unit to be inserted into or drawn from the main unit.

Because the optical disk has large storage capacity and low cost per unit storage capacity, the optical disk drives, which record information on and reproduce information from the optical disks, are being developed as main peripheral devices of computer devices, and studies have been undertaken primarily for increasing the reading speed of the disk drive.

Generally, higher rotational speed of the disk leads to higher data reading speed. If the standard rotational speed (200 rpm) of the initial optical disk drives is set as 1, 32 times-speed (6400 rpm) disk drives are commonly used presently, and 50 times-speed (10,000 rpm) disk drives have been produced recently.

From the point of view of manufacturing the optical disk drives, because personal computers are becoming more and more compact, the space for mounting an optical disk drive inside a computer becomes less and less. As a result, vertical installation of the optical disk drive is widely adopted; specifically, the optical disk drive is mounted vertically relative to the frame of the computer enclosure in a narrow space. In the related art, in the case of the vertical installation of the optical disk drive, the optical disk is held merely by the low peripheral wall of the recessed portion. Therefore, when loading or unloading the optical disk, the optical disk may slip down or topple over, making usage of the optical disk inconvenient in the case of vertical installation. For this reason, in an optical disk drive installed vertically, usually, parts for preventing slipping down or toppling over of an optical disk, such as claws or hooks, are provided at the edge of the recessed portion to loosely hold the optical disk at the side edge of the disk.

For example, Japanese Laid Open Patent Application No. 6-251479 discloses a disk rotational device suitable for loading a disk in the case of a vertical installation, in which movable hooks are formed separately at the edge of the recessed portion of the disk tray unit.

Japanese Laid Open Patent Application No. 2001-006246 discloses a disk player suitable for loading a disk in the case of a vertical installation by using only a springy member, in which one end of the springy member is fixed to the edge of the recessed portion of the disk tray unit, and the other end can be caught by a U-like end of a fixing member.

As shown above, in order for an optical disk drive installed vertically to load an optical disk, parts for preventing slipping down or toppling over of the optical disk, such as claws or hooks, need to be provided at the edge of the recessed portion of the optical disk (below, these parts are simply referred to as “toppling over preventing claw” where necessary). However, since the toppling over preventing claw is projecting in the region where the optical disk rotates at high speed (below, this region is referred to as “disk rotating region” where necessary), the claw becomes a source of vortices, and generates a so-called Karman vortex (or Karman vortex street). The Karman vortex (or Karman vortex street) causes the air near the rotating disk to vibrate, and vibration of the air further results in wind roar. That is, the toppling over preventing claw used in an optical disk drive installed vertically generates additional noise. Within a certain range of the rotational speed, the generation frequency of the Karman vortex due to disk rotation depends on the rotational speed, therefore, the wind roaring noise changes with the rotational speed.

In practical use, at a rotational speed lower than 10-times speed (2000 rpm), the noise generated from the optical disk drive is not noticeable. But at a rotational speed higher than 10-times speed, especially, a rotational speed higher than 32-times speed, this noise becomes quite strong.

The noise of wind roaring caused by disk rotation is generated not only when the toppling over preventing claw is constantly projecting in the disk rotating region in the case of vertical installation, but also when the movable toppling over preventing claw is used, as disclosed in the Japanese Laid Open Patent Applications as mentioned above. In the latter case, in usage, the claw is also projecting into the disk rotating region, and this also causes wind roaring noise.

In the related art, in order to suppress the wind roaring noise, a measure is taken to prevent the noise generated inside the optical disk drive from traveling to the outside through the opening on the front panel when the disk tray unit is set inside the optical disk drive. For example, a door is integrally attached to the optical disk drive and the outside end of the disk tray unit to close the opening, and a sealing member is placed between the door and the frame of the optical disk drive.

Such a door, however, is still not sufficient to suppress the noise in the latest optical disk drives having very high rotational speed. In addition, this door is visible to users, resulting in blemishing the appearance of the optical disk drive.

### SUMMARY OF THE INVENTION

Accordingly, it is a general object of the present invention to solve the above problems of the related art.

A first more specific object of the present invention is to provide a disk tray unit capable of suppressing noise generated when a disk rotates in a disk rotational device when loading the disk to or unloading the disk from the disk rotational device.

A second more specific object of the present invention is to provide a disk rotational device capable of suppressing noise generated when a disk rotates in the disk rotational device without blemishing the appearance thereof.

According to a first aspect of the present invention, there is provided a disk tray unit that is movably attached to a main body of a disk rotational device for conveying a disk from a predetermined position outside the main body to a disk rotating position inside the main body through an opening formed on a frame of the main body and conveying the disk from the disk rotating position inside the main body to the predetermined position outside the main body through the opening. The disk tray unit includes a tray having a recessed portion for accommodating the disk, and a disk holding member. The disk holding member has a front end of a smooth shape without unevenness, is formed on the peripheral wall of the recessed portion, and projects toward the inner side of the recessed portion so that the front end faces a portion of the periphery of the disk accommodated in the recessed portion.

According to the present invention, the disk holding member has a front end of a smooth shape without unevenness. This reduces resistance of the front end against the air stream when the disk rotates, and thus reduces the probability of generating Karman vortices. Consequently, it is possible to suppress the wind roar and reduce the noise generated when the disk rotates.

It is clear that the effect of noise reduction of the present invention is achievable no matter how the disk rotational device and the disk tray unit are installed, horizontally or vertically (horizontal installation or vertical installation).

As an embodiment, a number of the disk holding members are arranged, and these disk holding members are arranged to cover the periphery of the disk. This arrangement further suppresses the wind roar, and therefore further reduces the noise generated when the disk rotates.

As an embodiment, the front end of the disk holding member may be in a shape of an arc forming a portion of a circle or an ellipse. Further, at least a side of the disk holding member facing the disk may form a rounded surface. As a result, the cross section of the front end is in a stream-line shape; this reduces resistance of the front end against the air stream when the disk rotates, and thus reduces wind roar and noise generated when the disk rotates.

According to a second aspect of the present invention, there is provided a disk rotational device for driving a disk to rotate at a disk rotating position. The disk rotational device includes a main body having a frame with an opening formed thereon, and a disk tray unit movably attached to the main body for conveying the disk from a predetermined position outside the main body to the disk rotating position inside the main body through the opening on the frame, and conveying the disk from the disk rotating position inside the main body to the predetermined position outside the main body through the opening. The disk tray unit includes a tray including a recessed portion for accommodating the disk, and a disk holding member that has a front end of a smooth shape without unevenness. The disk holding member is formed on the peripheral wall of the recessed portion, and projects toward the inner side of the recessed portion so that the front end faces a portion of the periphery of the disk accommodated in the recessed portion.

According to the present invention, no matter whether the horizontal installation case or the vertical installation case, it is possible to suppress the wind roar and reduce the noise generated when the disk rotates.

In addition, in the present invention, the noise is reduced without adding any noise insulation member on the frame of the disk rotational device, for example, around the opening. Therefore, the object of noise reduction is attained without blemishing the appearance of the disk rotational device, and a silent disk drive can be obtained.

As an embodiment of the present invention, the disk may be an information storage medium, and the disk rotational device may further comprise a head unit arranged inside the frame, which head unit at least performs reproduction of information on the information storage medium among operations of recording the information on the information storage medium, deleting the information on the information storage medium, and reproducing the information on the information storage medium.

In addition, the information storage medium may be an optical disk, and the head unit may an optical pickup. That is, the disk rotational device may be an optical disk drive.

It should be noted that in this specification the term “disk” may generally cover a “circular plate”, or a “circular plate-like object”, but does not mean just a disk storage medium such as an optical disk. Further, the term “disk holding member” may cover an object like a claw or a hook, especially used in the vertical installation case, for holding the disk accommodated in the recessed portion of the disk tray unit to prevent slipping down or toppling over of the disk.

These and other objects, features, and advantages of the present invention will become more apparent from the following detailed description of preferred embodiments given with reference to the accompanying drawings.

### BRIEF DESCRIPTION OF THE DRAWINGS

FIG. 1 is a schematic perspective view of an optical disk drive 100 as an embodiment of the disk rotational device of the present invention;

FIG. 2 is an exploded perspective view of a principal portion of the optical disk drive 100 shown in FIG. 1;

FIG. 3 is a plan view of the disk tray unit 81 shown in FIG. 1 according to the present embodiment;

FIG. 4 is a cross-sectional view of the disk tray unit 81 along the B-B line in FIG. 3;

FIG. 5 is a plan view of the interior of the optical disk drive 100 showing a tray driving mechanism 30 inside the frame 91 with the cover 20 being partially removed;

FIG. 6A is a plan view showing the situation in which the disk tray unit 81 is at the disk loading position in the case of vertical installation with the optical disk 10 being loaded in the disk tray unit 81;

FIG. 6B is a plan view showing the situation in which the disk tray unit 81 is at the recording and reproduction position inside the disk drive 90 in the case of vertical installation with the optical disk 10 being loaded in the disk tray unit 81;

FIG. 7A is a cross-sectional view showing the relative relation of the positions of the optical disk 10 and the turn table 32;

FIG. 7B is a cross-sectional view showing a method of holding the optical disk 10 by the turn table 32;

FIG. 8 is a plan view of the disk tray unit 81, showing a modification to the embodiment of the present invention;

FIG. 9A is a cross-sectional view of the disk tray unit 81 along the C-C line in FIG. 8; and

FIG. 9B is a cross-sectional view of the disk tray unit 81 along the D-D line in FIG. 8.

### DESCRIPTION OF THE PREFERRED EMBODIMENTS

Below, preferred embodiments of the present invention are explained with reference to the accompanying drawings.

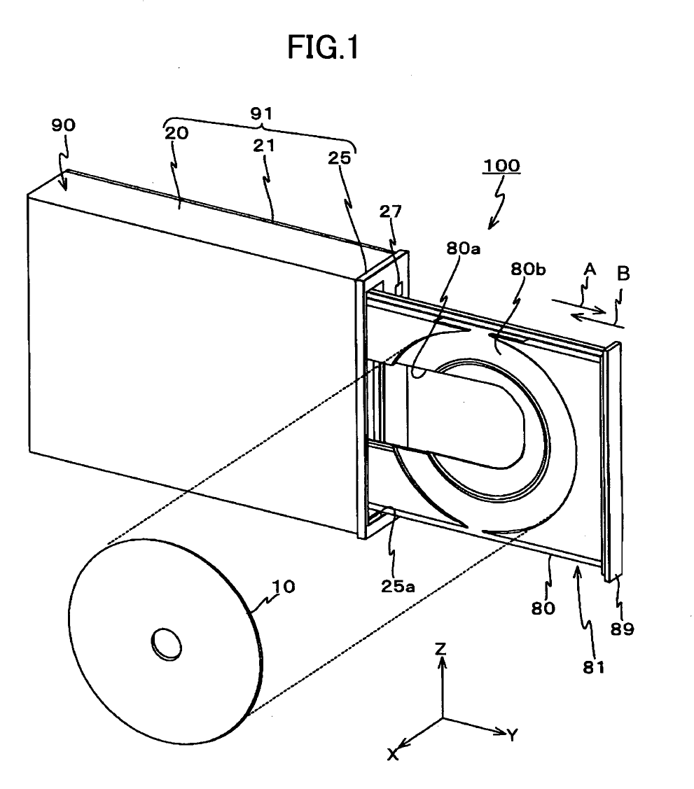

FIG. 1 is a schematic perspective view of an optical disk drive 100 as an embodiment of the disk rotational device of the present invention.

The optical disk drive 100 (below, just abbreviated as “disk drive”) moves an optical disk 10 in or out, and records, reproduces, or deletes information on the inserted optical disk 10. For example, the optical disk 10 is a storage medium in compliance with the standard of a Compact Disk (CD), such as a CD-R (Compact Disk-recordable), and a CD-RW (Compact Disk-rewritable).

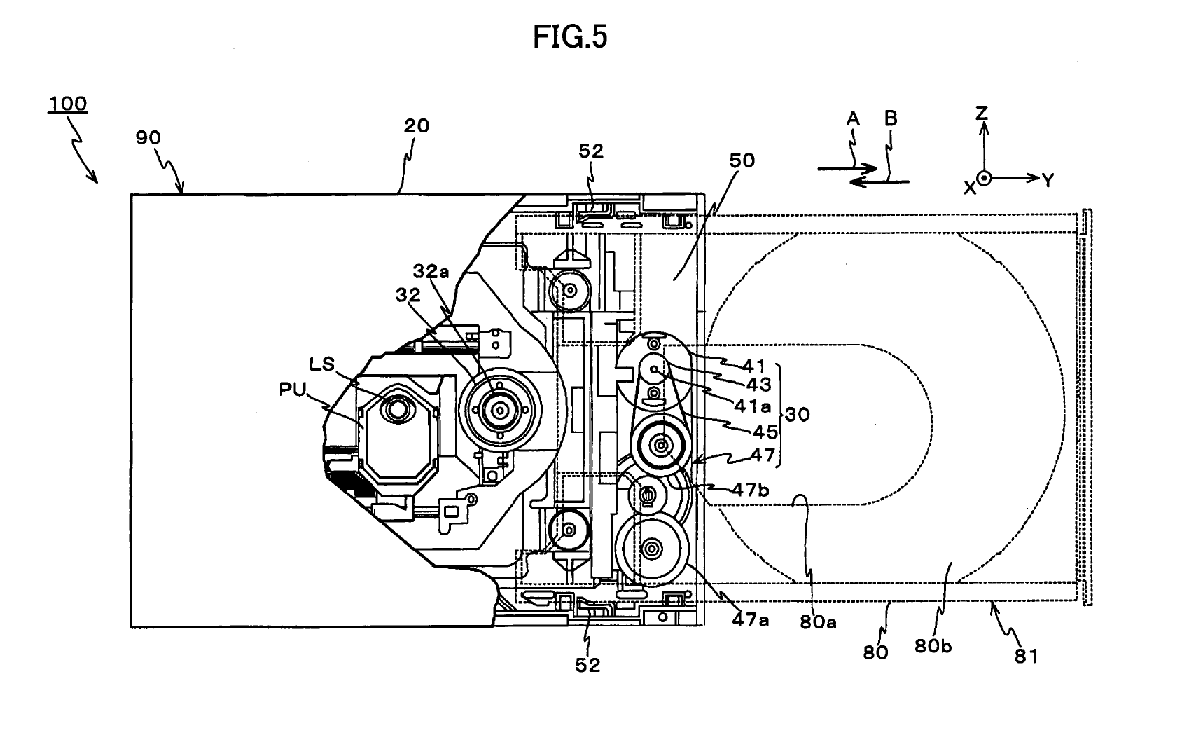

The disk drive 100 has a main unit 90 including an optical pickup PU (shown in FIG. 5) for recording data on the optical disk 10 and reproducing or deleting data recorded on the optical disk 10, a box-like frame 91 of the main unit 90, and a disk tray unit 81 movably attached to the frame 91.

The disk tray unit 81 is movable in the directions indicated by the arrows A and B (that is, along the + and −Y directions), and is used to load the optical disk 10 to a disk rotating position (described below) in the frame 91, and unload the optical disk 10 from the disk rotating position to a position outside the frame 91.

The disk tray unit 81 has a tray body 80 and a door 89 joined to one side of the tray body 80 (the +Y side). When the disk tray unit 81 is inserted at the disk rotating position, the door 89 is moved to a limit position in the direction B, and is fit into an opening 25a on a front bezel 25, which is a portion of the frame 91, and the front side of the disk drive 100 appears as a smooth surface. The detailed configuration of the disk tray unit 81 is described below.

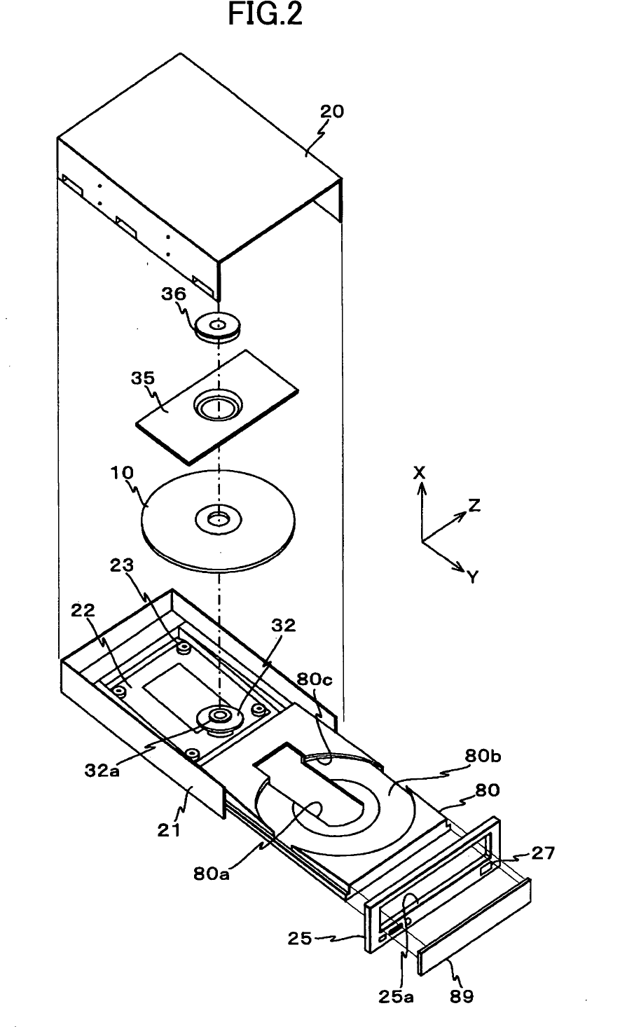

FIG. 2 is an exploded perspective view of a principal portion of the optical disk drive 100.

As shown in FIG. 2, the frame 91 has a base 21 including a bottom and three side walls standing on the +Z side, −Z side and −Y side of the bottom, a top cover 20 that covers the upper side and the three side walls of the base 21, and the front bezel 25 covering an open side (the +Y side, that is, the front side) of the box formed by the base 20 and the top cover 21. The opening 25a is formed on the front bezel 25 in a region close to the +X side of the front bezel 25.

The base 21 and the top cover 20 may be formed with metal plates so as to tolerate external shock. The front bezel 25 may be formed from plastic.

As shown in FIG. 1 and FIG. 2, an eject button 27 is provided on the front bezel 25 near the opening 25a to eject the disk tray unit 81. The disk tray unit 81 is movably attached to the main unit 90 and is movable within a specified range so as to convey the optical disk 10 from a position outside where the optical disk 10 is set in the disk tray unit 10 through the opening 25a to a position inside where the optical disk 10 is driven to rotate, and convey the optical disk 10 from the position inside through the opening 25a to the position outside.

Specifically, if the eject button 27 is pushed, a signal is sent to a not-illustrated controller, and the controller directs a motor to drive the disk tray unit 80.

The constituent parts of the disk drive 100 are accommodated in the base 21. As shown in FIG. 2, a chassis 22 is set in the base 21, and vibration absorbers 23 are set near the four corners of the chassis 22. The two vibration absorbers 23 on the −Y side are screwed and fixed to a not-illustrated fixation member. The end of the chassis 22 on the +Y side is moved up and down in the X directions by a not-illustrated up-and-down mechanism so that the chassis 22 can swing relative to an axis arranged near the end of the chassis 22 on the −Y side. The two vibration absorbers 23 on the +Y side are screwed and fixed to the mechanism moving the end of the chassis 22 up and down. A turn table 32 is provided near the end of the chassis 22 on the +Y side to act as a rotation driving mechanism, and a boss 32a for holding the optical disk 10 is set at the rotational center of the turn table 32. The turn table 32 is driven by a not-illustrated spindle motor.

A clamper plate 35 is arranged above the base 21 with the two ends thereof being fixed to the base 21. A disk damper 35 is attached to the damper plate 36 to face the turn table 32.

After the optical disk 10 is loaded on the turn table 32, the up-and-down mechanism moves up the chassis 22, and the disk damper 36 presses the optical disk 10 against the turn table 32; thus the optical disk 10 is sandwiched by the disk clamper 36 and the turn table 32. Then, the turn table 32 is driven to rotate by the not-illustrated spindle motor, and the optical disk is driven to rotate. Because the optical disk 10 is driven to rotate by the turn table 32, the aforementioned disk rotating position is the position of the turn table 32.

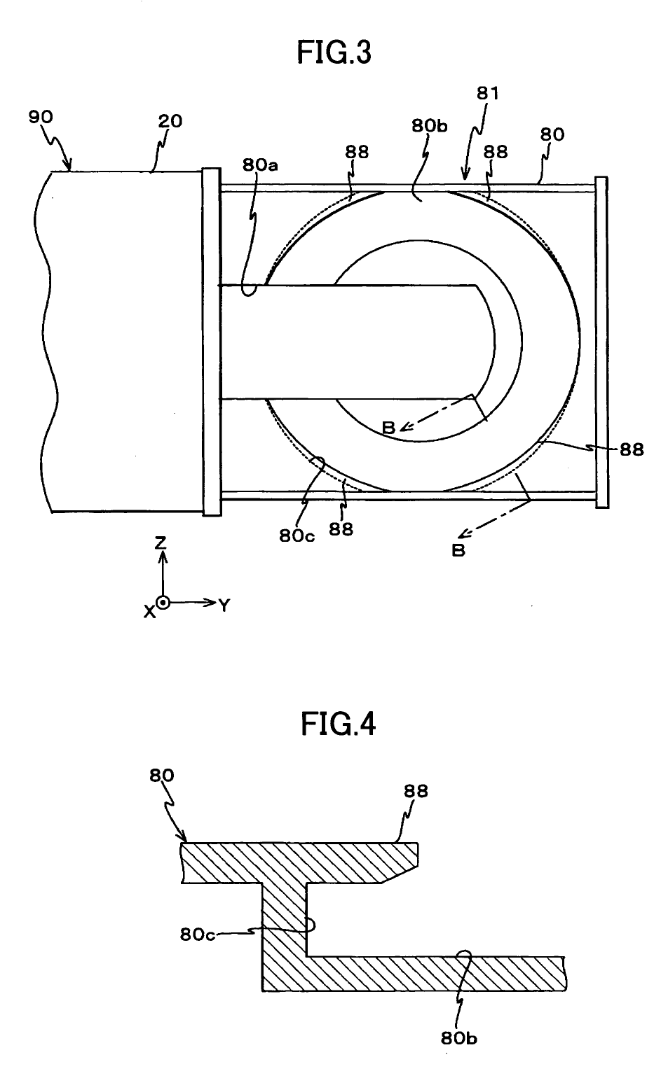

Next, the structure of the disk tray unit 81 is explained with reference to FIG. 3 and FIG. 4.

FIG. 3 is a plan view of the disk tray unit 81 according to the present embodiment.

FIG. 4 is a cross-sectional view of the disk tray unit 81 along the B-B line in FIG. 3.

The disk tray unit 81 may be formed from plastic. As shown in FIG. 3, a nearly circular stepped recessed portion 80b is formed on the front surface (surface on the +X side) of the disk tray unit 81. For example, a 12-inch CD or other optical disk is set in the first step of the recessed portion 80b, and an 8-inch CD or other optical disk is set in the second step of the recessed portion 80b. Below, when the term “recessed portion 80b” is used, it covers both of these steps.

As shown in FIG. 3, an opening 80a is formed through the disk tray unit 81 in the X directions. The opening 80a is shaped so that the disk tray unit 81 does not mechanically interfere with the turn table 32 or the optical pickup PU.

On the rear surface of the disk tray unit 81 (surface on the −X side), although not illustrated, grooves are formed along the Y directions near the ends on the +Z and −Z sides of the rear surface of the disk tray unit 81. Not-illustrated racks are formed on the inner surface of the side wall of the disk tray unit 81 on the −Z side, and the racks extend along the X directions.

On the wall 80c at the periphery of the recessed portion 80b (below, referred to as “peripheral wall”), as shown in FIG. 3 and FIG. 4, eaves 88 projecting toward the inner side of the recessed portion 80b are formed at four places near the +Z and −Z sides of the disk tray unit 81. The eaves 88 correspond to the “disk holding member” of the invention.

The shape of the front end of each eave 88 is formed smooth without unevenness, for example, the front end of each eave 88 may be in a shape of an arc, that is, a part of a circle or an ellipse. As shown in FIG. 3, the portion of the eaves 88 closer to the +Z or −Z ends projects more; near the center of the Z directions, the projection of the eaves 88 is nearly zero. Making the eaves 88 in such a shape is for preventing slipping down and toppling over of the optical disk 10, because in the case of vertical installation, the thicker portion of the eaves 88 may be on the lower side to hold the lower edge of the optical disk 10.

FIG. 5 is a plan view of the interior of the disk drive 100 showing a tray driving mechanism 30 inside the frame 91 with the cover 20 being partially removed.

The tray driving mechanism 30 drives the disk tray unit 81 in the directions A and B indicated in FIG. 5. As shown in FIG. 5, the tray driving mechanism 30 includes a motor 41 that drives a rotational axis 41a to rotate clockwise or counter-clockwise, a pulley 43 fixed to the rotational axis 41a of the motor 41, a series of gears 47 near the motor 41, and a driving belt 45 to transmit the rotation of the pulley 43 to a gear 47b of the gear series 47. Among the gear series 47, the gear 47a is at the end on the −Z side; it meshes with the racks formed on the disk tray unit 81, functioning as a pinion.

By the tray driving mechanism 30 having the above configuration, when the rotational axis 41a of the motor rotates, the pulley 43 and gears in the gear series 47, via the driving belt 45, are driven to rotate clockwise or counter-clockwise. Therefore, the disk tray unit 81 is driven via the racks to move in the A and B directions. Here, for example, the tray driving mechanism 30 is a speed reduction mechanism, that is, the rotational speed of the motor 41 (specifically, the rotational axis 41a) is reduced by the pulley 43, the driving belt 45, and the gear series 47, and is transmitted to the gear 47a, and further to the racks.

The disk tray unit 81 is driven to move by a specified distance in the direction of A, and when the disk tray unit 81 reaches the position indicated by the dashed line in FIG. 5, a not-illustrated notch formed on the side surface of the disk tray unit 81 is caught in a stopper 52 arranged near the gear series 47, thereby stopping the disk tray unit 81 from moving further in the A direction. At this time, the recessed portion 80b of the disk tray unit 81 is ejected out of the disk drive 90 completely, thus a user may set the optical disk 10 into the recessed portion 80b, or take the optical disk 10 out of the recessed portion 80b. Below, the position of the disk tray unit 81 indicated by the dashed line in FIG. 5 is referred to as “disk loading position” where necessary.

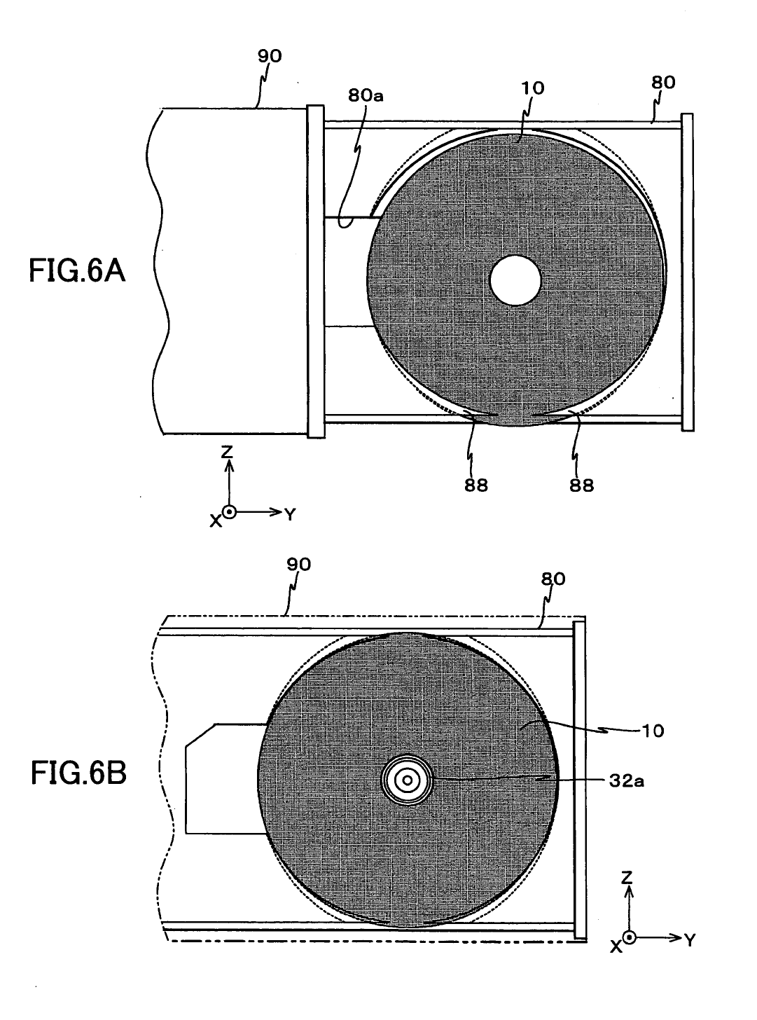

FIG. 6A is a view showing the situation in which the disk tray unit 81 is at the disk loading position and the optical disk 10 is being loaded in the case of vertical installation.

As shown in FIG. 6A, at the disk loading position, the optical disk 10 is held at a position that is slightly shifted downward (toward the −Z side) from the center of the recessed portion 80b.

When the disk tray unit 81 is driven to move by a maximum distance in the direction of B and is completely inserted in the disk drive 100, the disk drive 100 is positioned in such as way that the turn table 32 is at a small distance from the wall of the opening 80a on +Y side in the disk tray unit 81. At this position, if the optical disk 10 is loaded in the disk tray unit 81, the disk drive 100 can record, or reproduce, or delete data on the optical disk 10. Below, this position of the disk tray unit 81 is referred to as “recording and reproduction position” where necessary.

FIG. 6B is a view showing the situation in which the disk tray unit 81 and the loaded optical disk 10 are at the recording and reproduction position inside the disk drive 100 in the case of vertical installation.

As shown in FIG. 6B, at the recording and reproduction position, the boss 32a is fitted to a hole at the center of the optical disk 10.

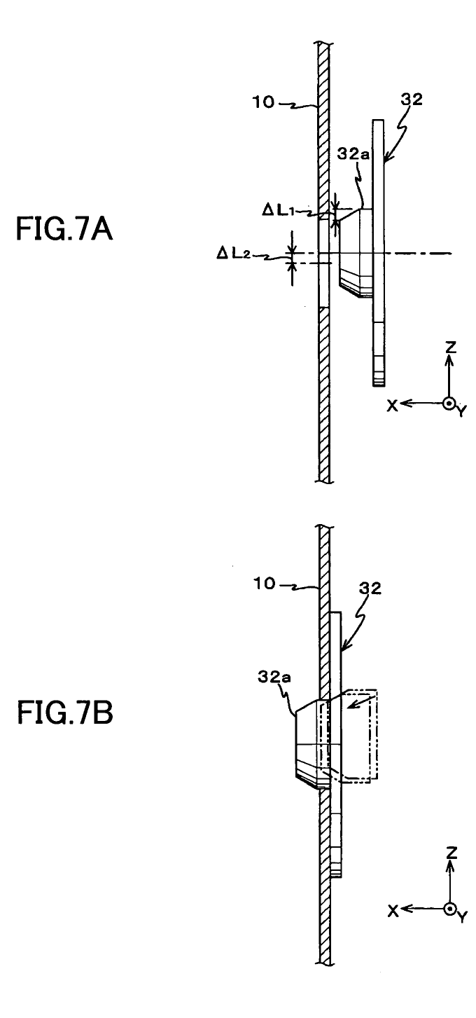

FIG. 7A is a cross-sectional view showing a relative relation of the positions of the optical disk 10 and the turn table 32, and FIG. 7B is a cross-sectional view showing a method of holding the optical disk 10 by the turn table 32.

As described above, the optical disk 10 is slightly shifted downward (toward the −Z side) from the center of the recessed portion 80b, therefore, the height (position in the Z direction) of the turn table 32 is not in agreement with the height of the hole at the center of the optical disk 10.

As shown in FIG. 7A, however, because the end of the boss 32a is machined in a taper shape, even though the height of the turn table 32 is not in agreement with the height of the hole at the center of the optical disk 10, the boss 32a can still enter into the center hole of the optical disk 10 and adjust the height of the optical disk 10 to make heights of the turn table 32 and the center hole of the optical disk 10 in agreement, and thereby, the optical disk 10 is held by the turn table 32. In other words, the boss 32a functions as a guide to adjust the height of the optical disk 10.

Specifically, the optical disk 10 can be held by the boss 32a, if the difference ΔL₁ between the radius of the front end of the boss 32a and the radius of the portion of the boss 32a actually holding the optical disk 10 is less than the difference ΔL₂ between the height of the center of the hole of the optical disk 10 and the height of the rotational center of the turn table 32.

In FIG. 7B, it appears that the turn table 32 is moved in the −Z direction, but actually, because the turn table 32 is driven by the up-down mechanism to move only in the X direction, it is the optical disk 10 that is moved in the Z direction to adjust the height.

Returning to FIG. 5, the aforementioned optical pickup PU is installed on the −Y side of the turn table 32. The optical pickup PU emits a laser beam to the recording surface of the optical disk 10, and receives the reflected light from the recording surface. The optical pickup PU has a driving mechanism for driving an object lens LS of the optical pickup PU to move in the Y and X directions relative to the optical disk 10.

Below, a brief explanation is made of the operation of the disk drive 100 having the above configuration.

When a user pushes the eject button 27 on the front bezel 25 shown in FIG. 1, a signal is sent to a not-illustrated controller, and the controller directs the motor 41 (specifically, the rotational axis 41a) to rotate clockwise or counter-clockwise (here, for example, counter clockwise). Rotation of the motor 41 (specifically, the rotational axis 41a) is transmitted to the gear 47 engaging the racks formed on the disk tray unit 81, through the pulley 43, the driving belt 45, and other gears in the gear series 47, driving the gear 47a to rotate counter-clockwise. As a result, the disk tray unit 81 is driven to move in the direction indicated by A as shown in FIG. 5. After the disk tray unit 81 is moved a certain distance, the notch formed on the side surface of the disk tray unit 81 is caught by the stopper 52, thereby positioning the disk tray unit 81 at the disk loading position. Then, a not-illustrated sensor detects that the disk tray unit 81 has been positioned at the disk loading position, and sends a signal to the controller, and the controller directs the motor 41 to stop.

At the disk loading position, the user may set the optical disk 10 to the recessed portion 80b, or if the optical disk 10 has already been set to the recessed portion 80b, the user may replace the optical disk 10 with a new optical disk. After that, the user pushes the eject button 27, or slightly pushes the disk tray unit 81 in the direction indicated by B. This operation is transmitted to the controller, and the controller directs the motor 41 to rotate in the opposite direction. Thereby, the gear 47a is driven to rotate clockwise, and drives the disk tray unit 81 to move in the direction of B.

When the disk tray unit 81 is moved to the recording and reproduction position, the central hole of the optical disk 10 is at the position of the end of the boss 32 (the +X side of the boss 32). Then, the turn table 32 is moved up by the up-down mechanism, and the optical disk 10 is sandwiched by the disk damper 36 and the turn table 32. Then, the turn table 32 is driven to rotate by the not-illustrated spindle motor, and at the same time, the optical pickup PU emits a laser beam to the recording surface of the optical disk 10, receives the reflected light from the recording surface, and converts the detected reflected light to electrical signals. After that, the optical pickup PU reads the state recorded in the read-in region of the optical disk 10. Then, the controller stops the turn table 32.

Next, in response to instructions from the user, the optical disk 10 is driven to rotate, and while the optical disk 10 is rotating, the optical pickup PU emits a laser beam to the recording surface of the optical disk 10 to record information, or delete or reproduce the existing information.

As described above, when the optical disk 10 is rotating in the above operations, the wind roaring generated in the rotation greatly increases the noise of the disk drive 100. And as has been described, the wind roaring is primarily caused by the Karman vortex. It is desirable to reduce the probability of formation of the Karman vortex street.

In the present embodiment, when the disk drive 100 is installed vertically, as shown in FIG. 3 and FIG. 4, four eaves 88 are formed on the upper side and the lower side of the recessed portion 80b to function as claws for holding the optical disk 10, and the shape of the front end of each eave 88 is formed smooth without unevenness. Because the above eaves 88 do not have portions causing an additional resistance against the air stream when the optical disk 10 rotates, the formation probability of the Karman vortices is reduced, and it suppresses generation of the wind roar.

An experiment was conducted to test the effect of reducing the noise of the disk drive 100 of the present embodiment in comparison with the disk drives of the related art with the commonly used hooks or springy plates.

Specifically, in the experiment, the optical disk was rotated at a 40-times speed (that is, 8000 rpm), and the sound pressure level (SPL) at the user position (or operator position) was measured. Here, the sound pressure level was measured at a band region where the sensitivity of human ears is high, that is, the A-weighted sound pressure level (in units of dB(A)), which is used as the normal noise level, was measured.

It was found that the average A-weighted sound pressure level of the disk drive of the related art was 46 dB(A); in contrast, the average A-weighted sound pressure level of the disk drive 100 of the present embodiment was 44 dB(A), less than the former one. That is, by using the disk drive 100 of the present embodiment, the noise perceived by the user is reduced.

As described above, in the disk drive 100 of the present embodiment, when the rotational axis of the optical disk is in the nearly horizontal direction (that is, vertical installation), a number of eaves 88 are formed on the disk tray unit 81 to function as claws for holding the optical disk 10, and loosely fit with at least portions of the periphery of the optical disk 10. The front end of each eave 88 has a smooth shape without unevenness, therefore, the resistance of the eaves 88 against the air stream when the optical disk 10 rotates is reduced. As a result, the probability of formation of Karman vortices is reduced, and it reduces the strength of the wind roar when the optical disk 10 rotates.

When the rotational axis of the optical disk is in the nearly vertical direction (that is, horizontal installation), similarly, due to the eaves 88, the strength of the wind roar when the optical disk 10 rotates is reduced.

In the disk drive 100 of the present embodiment, because the disk tray unit 81 is inserted inside the disk drive 100 in usage, the appearance of the disk drive 100 is not blemished. That is, the disk drive 100 of the present embodiment is able to suppress noise caused when the optical disk 10 rotates without blemishing the appearance thereof.

While the present invention is described above with reference to specific embodiments chosen for purpose of illustration, it should be apparent that the invention is not limited to these embodiments, but numerous modifications could be made thereto by those skilled in the art without departing from the basic concept and scope of the invention.

In the above, it is described that the portion of each eave 88 near the upper end and the lower end of the recessed portion 80b (+Z and −Z side) is longer than the portions of other eaves 88, as shown in FIG. 3 and FIG. 4, but the present invention is not limited to this; each eave 88 may also be formed to have the same projection length.

In the above, it is described that the eaves 88 do not extend to the upper end and the lower end of the recessed portion 80b (ends along the +Z and −Z directions), and the ends of the recessed portion 80b along the +Y and −Y directions, as shown in FIG. 3, but the present invention is not limited to this; each eave 88 may also be formed along the whole periphery of the recessed portion 80b as long as this design is practically possible. In this case, the eaves 88 also functions as sound insulation walls.

In the above, it is described that the eaves 88 are formed near both the upper end and the lower end of the recessed portion 80b (both the +Z side and −Z side) as shown in FIG. 3, but the present invention is not limited to this; if the disk drive 100 is only used in the vertical installation case, it is sufficient to form the eaves 88 only on the −Z side.

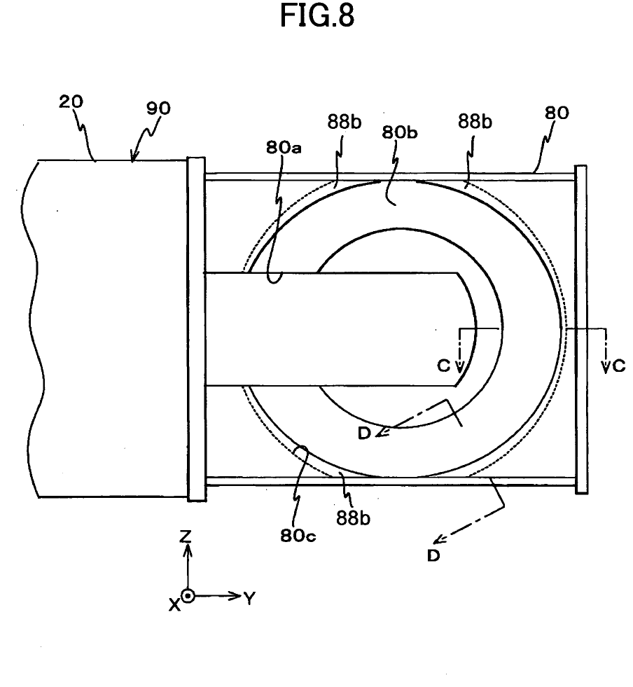

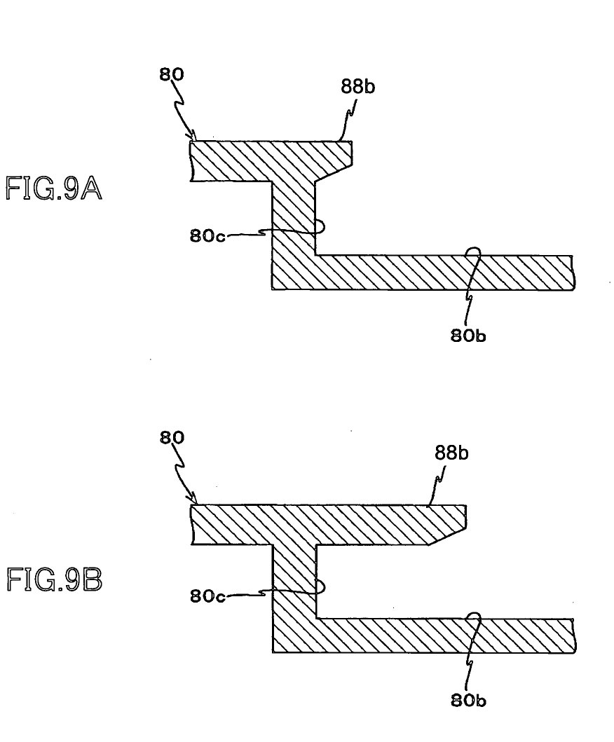

In the above, it is described that the eaves 88 are formed near the upper end and the lower end of the recessed portion 80b (ends along the +Z and −Z directions), where the optical disk 10 is held by the eaves 88, but the present invention is not limited to this. FIG. 8 and FIGS. 9A and 9B give an example.

FIG. 8 is a plan view of the disk tray unit 81, showing a modification to the above embodiment.

As shown in FIG. 8, the eave 88b is formed over nearly the whole peripheral wall of the recessed portion 80b and is projecting toward the inner side of the recessed portion 80b. This configuration of the eave 88b also suppresses generation of the wind roar, and thereby, the noise caused when the optical disk 10 rotates is reduced compared with the related art.

FIG. 9A is a cross-sectional view of the disk tray unit 81 along the C-C line in FIG. 8; FIG. 9B is a cross-sectional view of the disk tray unit 81 along the D-D line in FIG. 8.

As shown in FIGS. 9A and 9B, the eave 88b is formed over nearly the whole peripheral wall of the recessed portion 80b, and the portion of the eave 88b near the +Z end and −Z end of the recessed portion 80b is projecting more toward the inner side of the recessed portion 80b (FIG. 9B), and the portion of the eave 88b extending from the +Z and −Z ends of the recessed portion 80b has a shorter projection length (FIG. 9A). The same as the above embodiment, such a shape of the eaves 88 are for preventing slipping down and toppling over of the optical disk 10, because in the case of vertical installation the thicker portions of the eaves 88 may be on the lower side to hold the lower end of the optical disk 10.

In the above, it is described that the front end of the eaves 88 is formed to be in a smooth shape without unevenness, and may be in a shape of an arc, that is, a part of a circle or an ellipse, but the present invention is not limited to this; numerous kinds of shapes may also be adopted as long as these shapes can reduce the resistance of the eaves 88 against the air stream when the optical disk 10 rotates.

In the above, it is described that the front ends of all the eaves 88 are all in smooth shapes (for example, in a shape of an arc), but the present invention is not limited to this, it is possible to make some of the eaves 88 in the above form, and other eaves 88 in the form of the conventional claws. Even in this case, it is possible to reduce the strength of the wind roar.

In the above, it is described that the eaves 88 are additionally formed on the peripheral wall 80c of the disk tray unit 81, but the present invention is not limited to this. For example, the peripheral wall 80c may be formed to have a projection like an eave, and the front end of the eaves of the peripheral wall 80c may be formed to be in a smooth shape so as to reduce the resistance of the peripheral wall 80c against the air stream when the optical disk 10 rotates.

In the above, it is described that the tray driving mechanism 30 including the motor 41 is used to drive the disk tray unit 81, but the present invention is not limited to this. For example, a driving mechanism including an actuator other than a motor may also be used, or the disk tray unit 81 may also be moved manually. Furthermore, other methods may also be adopted. For example, the disk tray unit 81 is ejected out slightly from the main body 90 of the disk drive 100 when the user pushes the eject button 27 and releases the lock state of opening and closing of the disk tray unit 81, and then the user further draws the ejected disk tray unit 81 out.

In the above, it is described that the user pushes the eject button 27 to insert the disk tray unit 81 into or eject the disk tray unit 81 out of the disk tray unit 81, but the present invention is not limited to this. For example, insertion and ejection of the disk tray unit 81 may also be performed in response to instructions from a higher level device, for example, a computer.

In the above, it is described that the disk drive 100 and the loading mechanism are for an optical disk 10 in compliance with the standard of Compact Disks (CD), such as CD-Rs (Compact Disk-recordable), or CD-RWs (Compact Disk-rewritable), but the present invention is not limited to this. The present invention is applicable to other optical disks, for example, an optical disk or a laser disk (LD) in compliance with the standard of DVD. Further, the disk drive 100 may be configured to support both an optical disk in compliance with the CD standard and an optical disk in compliance with the DVD standard. In other words, the present invention is applicable to any kind of optical disk as long as the disk drive 100 is capable of at least data reproduction from the optical disk among data recording, reproduction and deletion. The information recording media may also be any media other than optical disks, as long as they can be set to the disk tray unit 81, and are loadable and unloadable by using the disk tray unit 81.

The disk drive of the present invention is not limited to vertical installation, in which the recording surface of the disk is perpendicular to the horizontal plane; the present invention is also applicable to horizontal installation, in which the recording surface of the disk is parallel to the horizontal plane.

Further, the disk tray unit of the present invention is not limited to that used in a disk drive; the present invention is applicable to any kind of device that drives plate-like disks (circular disks) to rotate; the plate-like disks are not limited to information recording media, so that any plate-like object that can be used while being rotated may be adopted.

Summarizing the effect of the invention, as described above, when the disk tray unit of the present invention is used in a disk rotational device to load and unload a disk, it is possible to suppress the noise generated when the disk rotates in the disk rotational device.

In addition, with the disk rotational device of the present invention, it is possible to suppress the noise generated when the disk rotates without blemishing the appearance of the device.

This patent application is based on Japanese Priority Patent Application No. 2003-020107 filed on Jan. 29, 2003, and the entire contents of which are hereby incorporated by reference.

What is claimed is:

1. A disk tray unit movably attached to a main body of a disk rotational device for conveying a disk from a predetermined position outside the main body through an opening formed on a frame of the main body to a disk rotating position inside the main body, and conveying the disk from the disk rotating position inside the main body through the opening to the predetermined position outside the main body, comprising:
a tray including a recessed portion for accommodating the disk; and
a disk holding member formed on a peripheral wall of the recessed portion, the disk holding member having a front end of a smooth shape without unevenness and projecting toward an inner side of the recessed portion so that the front end faces a portion of a periphery of the disk accommodated in the recessed portion.

2. The disk tray unit as claimed in claim 1, comprising a plurality of the disk holding members.

3. The disk tray unit as claimed in claim 2, wherein the disk holding members are arranged to cover the periphery of the disk.

4. The disk tray unit as claimed in claim 1, wherein the front end is in a shape of an arc forming a portion of a circle or an ellipse.

5. The disk tray unit as claimed in claim 1, wherein at least a side of the disk holding member facing the disk forms a rounded surface.

6. A disk rotational device for driving a disk to rotate at a disk rotating position, comprising:
a main body having a frame with an opening formed thereon; and
a disk tray unit movably attached to the main body for conveying the disk from a predetermined position outside the main body through the opening on the frame to the disk rotating position inside the main body, and conveying the disk from the disk rotating position inside the main body through the opening to the predetermined position outside the main body,
said disk tray unit comprising:
a tray including a recessed portion for accommodating the disk; and
a disk holding member formed on a peripheral wall of the recessed portion, the disk holding member having a front end of a smooth shape without unevenness and projecting toward an inner side of the recessed portion so that the front end faces a portion of a periphery of the disk accommodated in the recessed portion.

7. The disk rotational device as claimed in claim 6, wherein the disk is an information storage medium;
said disk rotational device further comprising a head unit arranged inside the frame and at least performs reproduction of information on the storage medium among operations of recording the information on the information storage medium, deleting the information on the information storage medium, and reproducing the information on the information storage medium.

8. The disk rotational device as claimed in claim 7, wherein
the information storage medium is an optical disk; and
the head unit is an optical pickup.
